(19) United States
(12) Patent Application Publication
(10) Pub. No.: US 2017/0168662 A1
(43) Pub. Date: Jun. 15, 2017

(54) Display Method and Electronic Device for Rapidly Positioning Play Time Point

(71) Applicants: Le Holdings (Beijing) Co., Ltd., Beijing (CN); Le Shi Zhi Xin Electronic Technology (Tianjin) Limited, Tianjin (CN)

(72) Inventor: Da Man, Tianjin (CN)

(21) Appl. No.: 15/244,425

(22) Filed: Aug. 23, 2016

Related U.S. Application Data
(63) Continuation of application No. PCT/CN2016/088551, filed on Jul. 5, 2016.

(30) Foreign Application Priority Data
Dec. 15, 2015 (CN) 2015109392347

(51) Int. Cl. G06F 3/0481; G06T 11/60

(52) U.S. Cl. CPC G06F 3/0481; G06T 11/60; G06T 2200/24

(57) ABSTRACT

Disclosed are a display method and electronic device for rapidly positioning a play time point. The method includes the steps of: acquiring a rapid positioning starting instruction, and determining a start time point and a start position on a progress bar at which the rapid positioning starting instruction is acquired; acquiring a positioning instruction, and determining a positioning time point and a positioning position on the progress bar at which the positioning instruction is acquired; and displaying the positioning time point in real time, and highlighting a rapid positioning region on the progress bar. According to the method, the rapid positioning region between the start position and the positioning position is highlighted, so that a user can visually determine the start position, thereby relatively accurately determining a play position according to comparison with the start position.

### CROSS REFERENCE TO RELATED APPLICATIONS

This application is a continuation of International Application No. PCT/CN2016/088551, filed Jul. 5, 2016, and claims priority to Chinese Patent Application No. 201510939234.7, filed on Dec. 15, 2015, the disclosures of which are hereby incorporated in their entirety by reference.

### TECHNICAL FIELD

The disclosure relates to the technical field of playing live video, and particularly relates to a display method and electronic device for rapidly positioning play time point.

### BACKGROUND

Currently, players include an audio and video player at a PC (Personal Computer) side, a player at a web page side, an APP (Application) audio and video player at a mobile side and an audio and video player at a television side, and a user sometimes need to rapidly position a time point of starting to play. Where, operations of rapid positioning include a fast-forward operation and a fast-backward operation, which allow to rapidly skipping to a time point in front of or behind the current play time point and then start playing.

When the audio and video executes VOD (Video on Demand), one type of VOD contents are from a local storage or an external storage (such as a USB (Universal Serial Bus) disk, a mobile hard disk and the like), and the other type of the VOD contents are from a remote network (such as RTSP, HLS, RTMP, MMS, SAMBA, FTP and DLNA) connection.

Based on the existing players, when a user performs the fast-forward operations and fast-backward operations, on one hand, the current time point may be not displayed, and on the other hand, a play progress bar directly overwrites an original play progress bar along with the change of the progress bar, and after the operations are completed, the playback is started from a new time point.

Such a UI (User Interface) operation interaction has a problem that after the user completes the fast-forward operation or fast-backward operation, the previous play time point is lost, and a time interval between the new play time point and the previous play time point also cannot be determined. If the new time point is not a play point of contents which the user intends to view, the user may continually perform fast-forward operation or fast-backward operation until the time point of the contents which the user intends to view is located.

If the user wants to find the time point of the contents which the user intends to view, such operations need to be performed repeatedly, and especially when the playback is performed through network connection, repeated caching and waiting affects user experience and also seriously increase a response processing load of the server. Especially when long medium files (such as 4K, 1080P and 3D (three-dimensional) videos) of a large code rate are played, the problem will be more serious.

### SUMMARY

In order to overcome the defect in the prior art that positioning the play point of a content needs to be repeatedly operated, and according to one aspect of the disclosure, a display method and electronic device for rapidly positioning play time point is provided.

In the first place, a display method for rapidly positioning the play time point provided by embodiment of the disclosure includes: acquiring a rapid positioning starting instruction, and determining a start time point and a start position on a progress bar at which the rapid positioning starting instruction is acquired; acquiring a positioning instruction, and determining a positioning time point and the positioning position on the progress bar at which the positioning instruction is acquired; and displaying the positioning time point in real time, and highlighting a rapid positioning region on the progress bar, wherein the rapid positioning region is a region between the start position and the positioning position on the progress bar.

In the second place, the embodiment of the disclosure further provides a non-transitory computer-readable storage medium storing executable instructions that, when executed by an electronic device, cause the electronic device to executing any of the above display method for rapidly positioning play time point.

In the third place, the embodiment of the disclosure further provides an electronic device, comprising: at least one processor; and a memory communicably connected with the at least one processor for storing instructions executable by the at least one processor, wherein execution of the instructions by the at least one processor causes the at least one processor to executing any of the above display method for rapidly positioning play time point.

According to a display method and device for rapidly positioning the play time point provided by the embodiment of the disclosure, the start position is determined when the rapid positioning starting instruction is acquired, meanwhile the positioning position is determined during the progress of the rapid positioning, and the rapid positioning region between the start position and the positioning position is highlighted, so that a user can visually determine the start position, thereby relatively accurately determining a play position according to comparison with the start position. By displaying the playback data in real time at the positioning position, the user can determine a playback image at the positioning position in real time so as to determine whether to end the positioning operation.

Other features and advantages of the disclosure will be illustrated in the following description of the specification, and partially become obvious in the specification, or are known by implementing the disclosure. The aims and other advantages of the disclosure can be fulfilled and achieved by structures specified in the specification, claims and accompanying drawings.

The technical solution of the disclosure will be further described in details below by the accompanying drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a display method for rapidly positioning a play time point in accordance with some embodiments.

FIG. 2 is a schematic diagram of a progress bar when a fast-forward positioning operation is performed in accordance with some embodiments.

FIG. 3 is a schematic diagram of a progress bar when a fast-backward positioning operation is performed in accordance with some embodiments.

FIG. 4 is another schematic diagram of the progress bar when the fast-forward positioning operation is performed in accordance with some embodiments.

FIG. 5 is a first structure chart of a display device for rapidly positioning a play time point in accordance with some embodiments.

FIG. 6 is a second structure chart of the display device for rapidly positioning the play time point in accordance with some embodiments.

FIG. 7 is a third structure chart of the display device for rapidly positioning the play time point in accordance with some embodiments.

FIG. 8 is a fourth structure chart of the display device for rapidly positioning the play time point in accordance with some embodiments.

FIG. 9 is a fifth structure chart of the display device for rapidly positioning the play time point in accordance with some embodiments.

FIG. 10 is a structure diagram of an electronic device for rapidly positioning a play time point in accordance with some embodiments.

### DETAILED DESCRIPTION

Embodiments of the disclosure will be described in details below in conjunction with the accompanying drawings, but it should be understood that the protection scope of the disclosure is not limited to the embodiments.

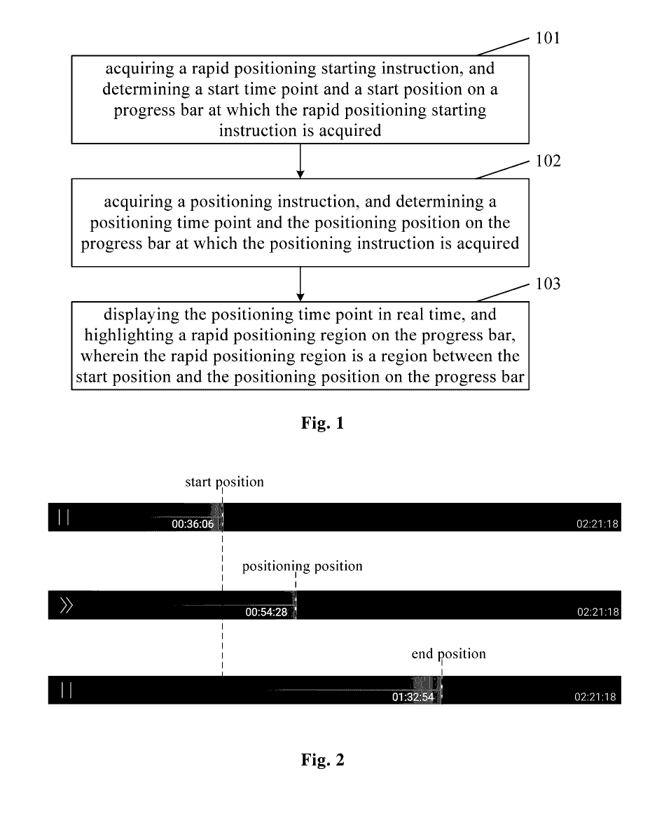

According to the embodiments of the disclosure, a display method for rapidly positioning a play time point is provided. FIG. 1 is a flow chart of the method. Particularly, the method includes the steps 101 to 103:

S101 includes acquiring a rapid positioning starting instruction, and determining a start time point and a start position on a progress bar at which the rapid positioning starting instruction is acquired.

In the embodiment of the disclosure, rapid positioning operations particularly can be classified into a fast-forward operation, a fast-backward operation and a skipping positioning operation, and the skipping positioning operation is to skip from a current play time point to another play time point, namely a fast-forward or fast-backward process is omitted. The rapid positioning starting instruction is configured for indicating to start the rapid positioning operation. Depending on various application contexts, ways by which a user sends the rapid positioning starting instruction may be vary. For example, if the user executes a fast-forward operation on a television by using a remote control, the rapid positioning starting instruction is acquired when the user presses a fast-forward key of the remote control; and if the user views a video by using a smart phone with a touch screen and the smart phone supports fast-forward or fast-backward operation by sliding on the screen, the rapid positioning starting instruction may be acquired when the user just touches the touch screen (at the moment, an operation of sliding the touch screen is not executed).

Particularly, the start time point is a time point at which the rapid positioning starting instruction is acquired, and the start position is a play position on the progress bar at which the rapid positioning starting instruction is acquired.

S102 includes acquiring a positioning instruction, and determining a positioning time point and the positioning position on the progress bar at which the positioning instruction is acquired.

In the embodiment of the disclosure, the positioning instruction is an instruction performed when the execution the positioning operations is in progress. Particularly, depending on various application scenarios, ways by which the user sends the positioning instruction are also vary. For example, if the user executes the fast-forward operation on the television by using the remote control, the positioning instruction is continuously acquired when the user continuously presses the fast-forward key of the remote control; and if the user views the video by using the smart phone with the touch screen and the smart phone supports the fast-forward or fast-backward operation by sliding the screen, the positioning instruction is continuously acquired when the user executes the operation of sliding the touch screen after touching the touch screen.

S103 includes displaying the positioning time point in real time, and highlighting a rapid positioning region on the progress bar, wherein the rapid positioning region is a region between the start position and the positioning position on the progress bar.

In the embodiment of the disclosure, after the positioning instruction is acquired, the positioning time point corresponding to the positioning instruction is displayed in real time at a position corresponding to the positioning position, and simultaneously, the rapid positioning region is highlighted, so that the user can visually determine a time interval between a current time point (i.e. the positioning time point) and the start time point, thereby estimating a position at which the rapid positioning operation ends.

Particularly, by taking the fast-forward operation as an example, with reference to FIG. 2, three figures in FIG. 2 respectively represent, from top to bottom, the progress bar when the fast-forward operation is started, the progress bar when the fast-forward operation is in progress and the progress bar when the fast-forward operation is ended, where as shown in the figures, the start time point when the rapid positioning starting instruction is acquired is at 00:36:06, the positioning time point is at 00:54:28 (the second figure in FIG. 2 only shows a schematic diagram of one time point during the rapid positioning process, and the positioning time point may be changed in real time along with the operations of the user), and an end time point is at 01:32:54; the start position, the positioning position and an end position are particularly as shown in FIG. 2; and the rapid positioning region is the region between the start position and the positioning position on the progress bar, particularly as shown in the second figure in FIG. 2.

Optionally, the method further includes: acquiring a rapid positioning ending instruction, and determining the end time point and the end position on the progress bar at which the rapid positioning ending instruction is acquired; and executing a playing operation at the end time point, and normal displaying the rapid positioning region.

Specifically with a specific reference to the third figure of FIG. 2, corresponding video streaming is played at the end time point (i.e. 01:32:54) after the rapid positioning ending instruction is acquired, and the progress bar is recovered to a normal display mode, i.e. the same mode as a display mode of the first figure in FIG. 2.

According to the display method for rapidly positioning the play time point provided by the embodiment of the disclosure, the start position is determined when the rapid positioning starting instruction is acquired, meanwhile, the positioning position is determined when the rapid positioning is in progress, and the rapid positioning region between the start position and the positioning position is highlighted, so that the user can visually determine the start position, thereby relatively accurately determining a play position according to comparison with the start position.

Optionally, in the embodiments of the disclosure, types of rapid positioning include: fast-forward positioning, fast-backward positioning and skipping positioning. The method further includes: according to the type of the rapid positioning, displaying a rapid positioning identification in real time when the positioning instruction is acquired.

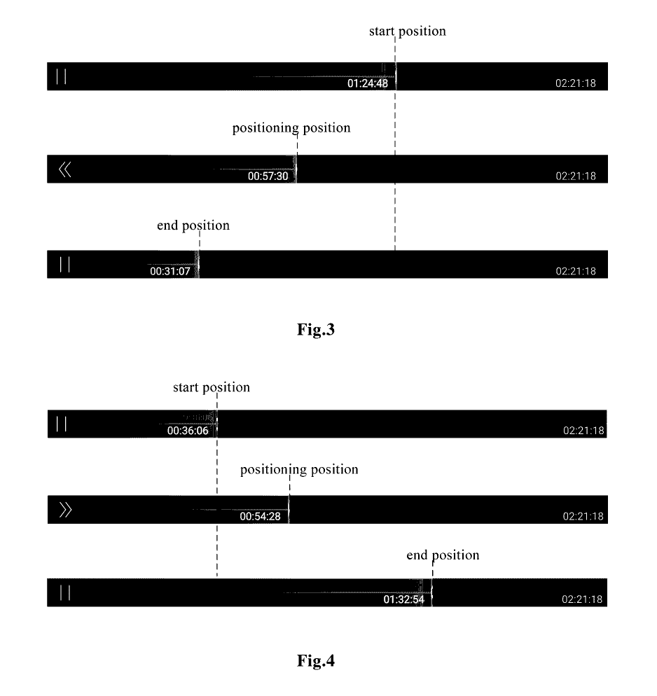

Particularly, in the embodiment of the disclosure, “∥” represents a playing state, a rapid positioning identification “>>” represents a fast-forward state, and a rapid positioning identification “<<” represents a fast-backward state. With reference to FIG. 2, the rapid positioning identifications are displayed at the leftmost side of the progress bar. Meanwhile, the schematic diagram of the fast-backward operation refers to FIG. 3, where the start time point is at 01:24:48, one of the positioning time points is at 00:57:30, and the end time point is at 00:31:07.

Optionally, after the step of acquiring the rapid positioning starting instruction, the method further includes: displaying the start time at a position corresponding to the start position. Particularly, with reference to FIG. 4, FIG. 4 differs from FIG. 2 in that the start time point 00:36:06 is added and displayed at the start position.

Optionally, after the step of acquiring the positioning instruction, the method further includes: acquiring corresponding playback data at the positioning time point in real time, wherein the playback data include playback images and/or video streaming; and displaying the playback data in real time. By displaying the playback data in real time at the positioning position, the user may determine a playback image at the positioning position in real time, thereby determining whether to end the positioning operation.

The above illustrates the process flow of the display method for rapidly positioning the play time point in details. The method may also be implemented by a corresponding device. The structure and functions of the device will be illustrated in details below.

The display device for rapidly positioning the play time point provided by the embodiments of the disclosure, with reference to FIG. 5, includes: a positioning starting module 51, a positioning module 52 and a highlighting module 53.

the positioning starting module 51 is configured for acquiring the rapid positioning starting instruction and determining the start time point and the start position on the progress bar at which the rapid positioning starting instruction is acquired;

the positioning module 52 is configured for acquiring the positioning instruction, and determining the positioning time point and the positioning position on the progress bar at which the positioning instruction is acquired; and

the highlighting module 53 is configured for displaying the positioning time point in real time, and highlighting the rapid positioning region on the progress bar, wherein the rapid positioning region is the region between the start position and the positioning position on the progress bar.

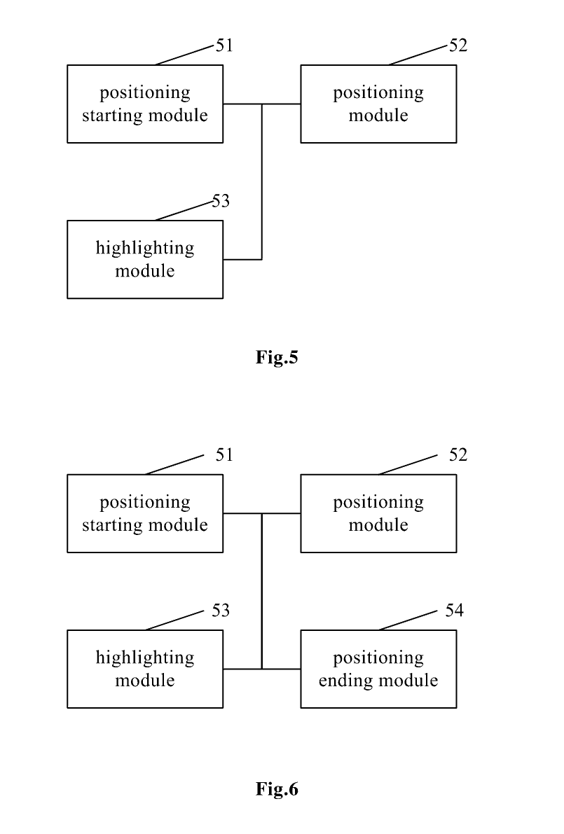

Optionally, with reference to FIG. 6, the device further includes: a positioning ending module 54, configured for acquiring the rapid positioning ending instruction, determining the end time point and the end position on the progress bar at which the rapid positioning ending instruction is acquired, executing the playing operation at the end time point and normal displaying the rapid positioning region.

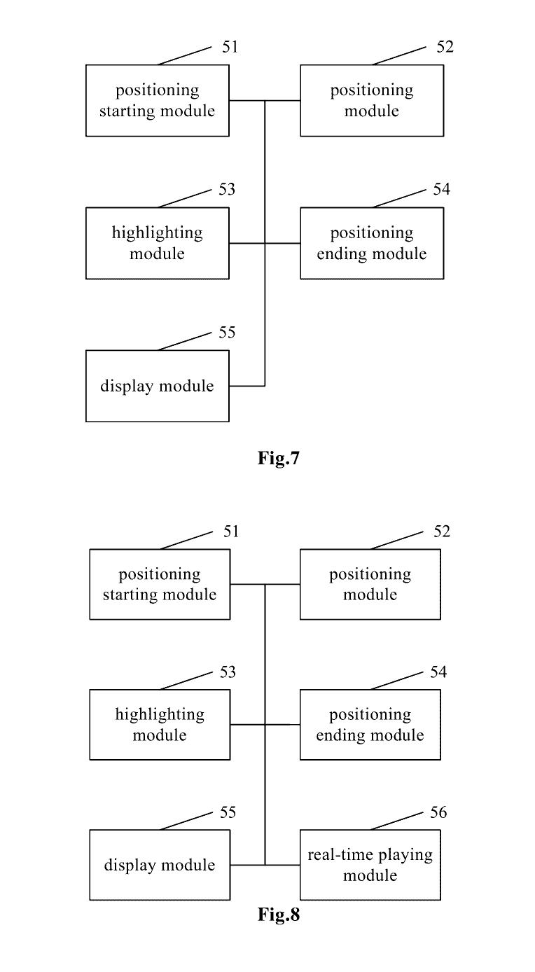

Optionally, with reference to FIG. 7, the device further includes a display module 55.

After the positioning starting module 51 acquires the rapid positioning starting instruction, the display module 55 is configured for displaying the start time at the position corresponding to the start position.

Optionally, with reference to FIG. 8, the device further includes a real-time playing module 56.

After the positioning module 52 acquires the positioning instruction, the real-time playing module 56 is configured for acquiring the corresponding playback data at the positioning time point in real time, and displaying the playback data in real time, wherein the playback data includes the playback images and/or the video streaming.

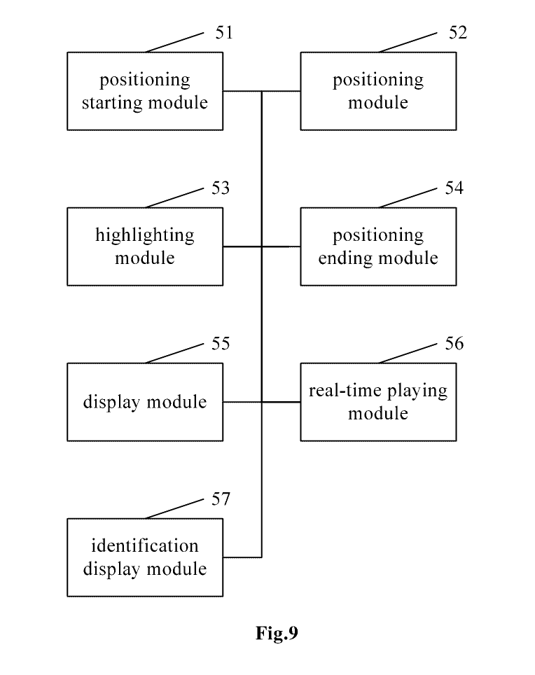

Optionally, the types of rapid positioning include: fast-forward positioning, fast-backward positioning and skipping positioning; and with reference to FIG. 9, the device further includes: an identification display module 57, configured for displaying the rapid positioning identification in real time when the positioning instruction is acquired, according to the type of the rapid positioning.

According to the display method and device for rapidly positioning the play time point provided by the embodiments of the disclosure, the start position is determined when the rapid positioning starting instruction is acquired, meanwhile the positioning position is determined when the rapid positioning is in progress, and the rapid positioning region between the start position and the positioning position is highlighted, so that the user can visually determine the start position, thereby relatively accurately determining the play position according to comparison with the start position. By displaying the playback data in real time at the positioning position, the user can determine the playback image at the positioning position in real time so as to determine whether to end the positioning operation.

According to the embodiment of the disclosure, a non-transitory computer-readable storage medium is provided, and the non-transitory computer-readable storage medium stores executable instructions that, when executed by an electronic device, cause the electronic device to executing the method for rapidly positioning a play time point provided by the above embodiments of the disclosure.

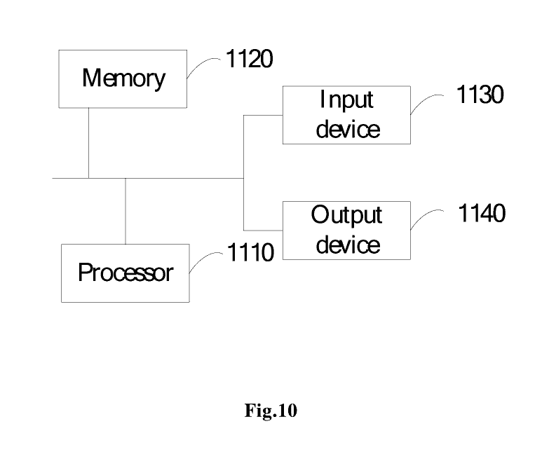

FIG. 10 is a schematic diagram of the hardware structure of electronic device executing the method for rapidly positioning a play time point, provided by an embodiment of the disclosure. As shown in FIG. 10, the device comprises one or more processors 1110 and a memory 1120. A case of one processor 1110 is taken as an example in FIG. 10.

The device executing the method for rapidly positioning a play time point further comprises an input device 1130 and an output device 1140.

The processor 1110, the memory 1120, the input device 1130 and the output device 1140 may be connected through a bus or in other ways. A case of bus connection is taken as an example in FIG. 10.

As a non-transitory computer-readable storage medium, the memory 1120 can be used for storing non-transitory software programs, non-transitory computer executable programs and modules, such as program instructions/modules (i.e., the positioning starting module 51, the positioning module 52 and the highlighting module 53 as shown in FIG. 5) corresponding to the method for rapidly positioning a play time point described in the embodiment of the disclosure.

The memory 1120 further comprises a program storage area and a data storage area, wherein the program storage area can store an operating system or application programs required by at least one function, and the data storage area can store data, etc., created according to using of the device for rapidly positioning a play time point. In addition, the memory 1120 may include a high speed random access memory and further may include a non-transitory memory, such as at least one disk memory, a flash memory, or other non-transitory solid-state memories. In some embodiments, the storage 1120 optionally include memories set up remotely relative to the processor 1110, and these remote memories can be connected to the device for rapidly positioning a play time point through a network. The above-mentioned networks include but are not limited to the Internet, Intranet, LAN, mobile communication networks and a combination thereof.

The input device 1130 can receive input figure or character information and generate key signal inputs in connection with user settings and function control of the device for rapidly positioning a play time point. The output device 1140 may include display devices such as a display screen.

The one or more modules are stored in the memory 1120 and are used for executing the method for rapidly positioning a play time point disclosed in any of the above-mentioned method embodiments when executed by one or more processors 1110.

The above-mentioned product can execute the method provided by the embodiments of the disclosure and has corresponding functional modules executing the method and beneficial effects. The technical details not described in the embodiment in detail are available with reference to the method provided by the embodiments of the disclosure.

The electronic device in the embodiments of the disclosure exists in many forms, including but not limited to:

Mobile communication equipment: this type of device is featured with a mobile communication function, and is mainly used for providing voice and data communication. These terminals include: a smartphone (e.g. iPhone), a multimedia phone, a functionality phone, and a low-end phone, and the like.

Ultra mobile personal computer equipment: this type of equipment belongs to the range of personal computers, and is provided with computation and processing functions, and typically has a mobile internet characteristic. These terminals include: PDA, MID and UMPC equipment, and the like, such as iPad.

Portable recreation equipment: this type of equipment can display and play multimedia contents. This type of equipment include: voice and audio players (such as iPod), handheld game players, e-books, intelligent toys and portable vehicle navigation equipment.

Servers: apparatus can provide computing service, and servers include: processors, hard disks, memories, system buses and the like, architecture of the servers is similar to that of a general-purpose computer, however, due to requirement for providing high-quality and reliable service, the requirements on processing capability, stability, reliability, safety, expandability, manageability and other aspects are higher.

Other electronic devices with a data interaction function.

The device embodiments described above are merely exemplary, wherein units described as separated components can be or cannot be separated physically, components displayed as units can be or cannot be physical units, namely can be located in one place, or can be distributed on multiple network units. The object of the solution of the embodiments can be achieved by selecting part or all of modules according to practical demands.

Based on the above description of the embodiments, it can be clearly appreciated by person skilled in the art that the embodiments can be implemented in a way of combination of software and a universal hardware platform or through hardware certainly. Based on such understanding, the nature of the above-mentioned technical solution or its part making contribution to relevant technology can be embodied in form of software. The computer software product can be stored in a computer-readable storage medium, such as ROM/RAM, a disk, CD, etc. and comprises a plurality of instructions for enabling one set of computer equipment (which may be a personal computer, a server or network equipment, etc.) to execute the method described in all embodiments or in part of an embodiment.

Finally, it should be noted that the above-mentioned embodiments are only used for explaining the technical solution of this application but not for limiting it. Even though this application has been described in detail with reference to the aforesaid embodiments, it should be understood that person skilled in the art still can modify the technical solutions disclosed in the above-mentioned embodiments or make equivalent substitutions to part of technical features; and these modifications or substitutions will not depart the corresponding technical solutions essentially from the spirit and scope of the technical solutions of all embodiments of this application.

What is claimed is:

1. A display method for rapidly positioning a play time point, executed by a terminal, comprising:
acquiring a rapid positioning starting instruction, and determining a start time point and a start position on a progress bar at which the rapid positioning starting instruction is acquired;
acquiring a positioning instruction, and determining a positioning time point and a positioning position on the progress bar at which the positioning instruction is acquired; and
displaying the positioning time point in real time, and highlighting a rapid positioning region on the progress bar, wherein the rapid positioning region is a region between the start position and the positioning position on the progress bar.

2. The method according to claim 1, further comprising:
acquiring a rapid positioning ending instruction, and determining an end time point and an end position on the progress bar at which the rapid positioning ending instruction is acquired; and
executing a playing operation at the end time point, and normal displaying the rapid positioning region.

3. The method according to claim 1, wherein after the step of acquiring the rapid positioning starting instruction, the method further comprises:
displaying the start time at a position corresponding to the start position.

4. The method according to claim 1, wherein after the step of acquiring the positioning instruction, the method further comprises:
acquiring corresponding playback data at the positioning time point in real time, wherein the playback data comprise playback images and/or video streaming; and
displaying the playback data in real time.

5. The method according to claim 1, types of rapid positioning comprise: fast-forward positioning, fast-backward positioning and skipping positioning; and
the method further comprises:
according to the type of the rapid positioning, displaying a rapid positioning identification in real time when the positioning instruction is acquired.

6. A non-transitory computer-readable storage medium storing executable instructions that, when executed by an electronic device, cause the electronic device to:
acquiring a rapid positioning starting instruction, and determining a start time point and a start position on a progress bar at which the rapid positioning starting instruction is acquired;
acquiring a positioning instruction, and determining a positioning time point and a positioning position on the progress bar at which the positioning instruction is acquired; and
displaying the positioning time point in real time, and highlighting a rapid positioning region on the progress bar, wherein the rapid positioning region is a region between the start position and the positioning position on the progress bar.

7. The non-transitory computer-readable storage medium according to claim 6, the said instructions is used for causing the electronic device to:
acquiring a rapid positioning ending instruction, and determining an end time point and an end position on the progress bar at which the rapid positioning ending instruction is acquired; and
executing a playing operation at the end time point, and normal displaying the rapid positioning region.

8. The non-transitory computer-readable storage medium according to claim 6, wherein after the step of acquiring the rapid positioning starting instruction, the method further comprises:
displaying the start time at a position corresponding to the start position.

9. The non-transitory computer-readable storage medium according to claim 6, wherein after the step of acquiring the positioning instruction, the method further comprises:
acquiring corresponding playback data at the positioning time point in real time, wherein the playback data comprise playback images and/or video streaming; and
displaying the playback data in real time.

10. The non-transitory computer-readable storage medium according to claim 6, types of rapid positioning comprise: fast-forward positioning, fast-backward positioning and skipping positioning; and
the method further comprises:
according to the type of the rapid positioning, displaying a rapid positioning identification in real time when the positioning instruction is acquired.

11. An electronic device, comprising:
at least one processor; and
a memory communicably connected with the at least one processor for storing instructions executable by the at least one processor, wherein execution of the instructions by the at least one processor causes the at least one processor to:
acquiring a rapid positioning starting instruction, and determining a start time point and a start position on a progress bar at which the rapid positioning starting instruction is acquired;
acquiring a positioning instruction, and determining a positioning time point and a positioning position on the progress bar at which the positioning instruction is acquired; and
displaying the positioning time point in real time, and highlighting a rapid positioning region on the progress bar, wherein the rapid positioning region is a region between the start position and the positioning position on the progress bar.

12. The electronic device according to claim 11, wherein execution of the instructions by the at least one processor causes the at least one processor to:
acquiring a rapid positioning ending instruction, and determining an end time point and an end position on the progress bar at which the rapid positioning ending instruction is acquired; and
executing a playing operation at the end time point, and normal displaying the rapid positioning region.

13. The electronic device according to claim 11, wherein after the step of acquiring the rapid positioning starting instruction, the method further comprises:
displaying the start time at a position corresponding to the start position.

14. The electronic device according to claim 11, wherein after the step of acquiring the positioning instruction, the method further comprises:
acquiring corresponding playback data at the positioning time point in real time, wherein the playback data comprise playback images and/or video streaming; and
displaying the playback data in real time.

15. The electronic device according to claim 11, types of rapid positioning comprise: fast-forward positioning, fast-backward positioning and skipping positioning; and
the method further comprises:
according to the type of the rapid positioning, displaying a rapid positioning identification in real time when the positioning instruction is acquired.
